(19) United States
(12) Patent Application Publication
(10) Pub. No.: US 2026/0259797 A1
(43) Pub. Date: Sep. 3, 2026

(54) COMBINED PASSTHROUGH AND LINK PARITY INFORMATION

(71) Applicant: Micron Technology, Inc., Boise, ID (US)

(72) Inventor: Scott E. SCHAEFER, Boise, ID (US)

(21) Appl. No.: 19/443,622

(22) Filed: Jan. 8, 2026

Related U.S. Application Data
(60) Provisional application No. 63/764,841, filed on Feb. 28, 2025.

(51) Int. Cl. G06F 11/10

(52) U.S. Cl. CPC G06F 11/1076

(57) ABSTRACT

In some implementations, a memory apparatus may obtain, from a host system, a first message including data and parity information associated with the data. The memory apparatus may perform an error control operation on the data using the parity information. The memory apparatus may store the data and the parity information to the memory apparatus.

### CROSS-REFERENCE TO RELATED APPLICATION

This Patent Application claims priority to U.S. Provisional Patent Application No. 63/764,841, filed on February 28, 2025, entitled “COMBINED PASSTHROUGH AND LINK PARITY INFORMATION,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to combined passthrough and link parity information.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

### BRIEF DESCRIPTION OF THE DRAWINGS

FIG. 1 shows an example of a system that supports combined passthrough and link parity information.

FIG. 2 shows an example of a data packet that supports combined passthrough and link parity information.

FIGS. 3A and 3B are diagrams of an example of combined passthrough and link parity information.

FIG. 4 is a flowchart of an example method associated with combined passthrough and link parity information.

FIG. 5 is a flowchart of an example method associated with combined passthrough and link parity information.

FIG. 6 is a flowchart of an example method associated with combined passthrough and link parity information.

### DETAILED DESCRIPTION

Some systems may operate according to a protocol that supports a write burst mode in which a host system communicates a data packet to a memory system. The memory system may store a payload (e.g., user data) included in the data packet to one or more memory devices of the memory system. The data packet may further include control information associated with the payload, such as passthrough parity information and/or communication control information associated with communicating the data packet.

Passthrough parity information may include parity information (e.g., one or more error correction codes (ECCs) and/or one or more error detection codes (EDCs)) generated by the host system as part of writing a data packet. Other types of parity information for data, such as in-line parity information, may be written by issuing multiple write commands (e.g., one or more write commands to write the data as well as one or more write commands to write the in-line parity information). Alternatively, if implementing passthrough parity information, the host system may write all or a portion of the passthrough parity information concurrent with writing all or a portion of the payload, for example by transmitting both the payload and the passthrough parity information in a single data packet, which may reduce the time and/or quantity of commands used to write the passthrough parity information and the payload. As part of reading the data packet, the host system may obtain and use the passthrough parity information to detect and/or correct one or more errors in the data packet.

Communication control information may be used to improve the reliability of communicating the data packet. For example, the communication control information may include link parity information. Link parity information may be parity information used to detect and/or correct one or more errors in the data packet that occur during communication (e.g., transmission and/or reception) of the data packet between the host system and the memory system. For example, a write-link error may be an error that occurs during transmission of a data packet from the host system to the memory system. Similarly, a read-link error may be an error that occurs during transmission of a data packet from the memory system to the host system.

For example, to communicate a data packet from the host system to the memory system, the host system may generate link parity information using the payload. The host system may provide the data packet, which may include the payload and the link parity information, to the memory system. After obtaining the data packet, the memory system may detect and/or correct one or more errors in the payload using the link parity information. The memory system may then store the payload to the one or more memory devices. Thus, by implementing link parity information, the host system and/or the memory system may reduce the likelihood of such link errors.

However, some communication protocols may not allow or may limit the ability of the host system and/or the memory system to include both link parity information and end-to-end parity information in a data packet. For example, some communication protocols may provision a fixed quantity of bits of the data packet to be used for control information. If a data packet includes separate passthrough parity information and link parity information, then the data packet may not be able to include other types of control information, such as system metadata, inversion information, and/or error reporting information, among other examples.

Some implementations described herein enable a host system and/or a memory system to combine passthrough parity information and link parity information. For example, as part of generating a first data packet for a write burst operation, the host system may generate passthrough parity elements by performing an error control operation on a payload of the first data packet. The host system may place the passthrough parity information in one or more portions of the first data packet provisioned for communication control information. The host system may provide, and the memory system may obtain, the first data packet. After obtaining the first data packet, the memory system may use the passthrough parity information to perform an error control operation on the first data packet. The memory system may store the enhanced passthrough parity information to one or memory arrays provisioned for parity information associated with the first data packet

Subsequently, as part of a read operation for the payload, the memory system may generate a second data packet. For example, the memory system may retrieve the payload and the passthrough parity information from one or more memory arrays. The memory system may place the payload and the passthrough parity information in the second data packet. The memory system may provide, and the host system may obtain, the second data packet. Based on, in response to, or otherwise associated with obtaining the second data packet, the host system may perform an error control operation on the second data packet using the passthrough parity information to detect and/or correct one or more errors in the second data packet.

As a result, by enabling combined passthrough and link parity information, the host system and/or the memory system may reduce the quantity of operations used to implement host-managed parity protection for a data packet while reducing the likelihood of errors occurring during transmission of the data packet. For example, by including passthrough parity information in a data packet, the host system may improve the reliability of the data packet without issuing additional access commands for other types of parity information, such as in-line parity information. Additionally, by using the passthrough parity information to detect and/or correct write-link errors in a data packet, the memory system may improve the reliability of the data packet without using additional system resources to manage additional link parity information. Such combined passthrough and link parity information may also allow for additional control information to be included in a data packet, such as system metadata, inversion information, and/or error reporting information, among other examples.

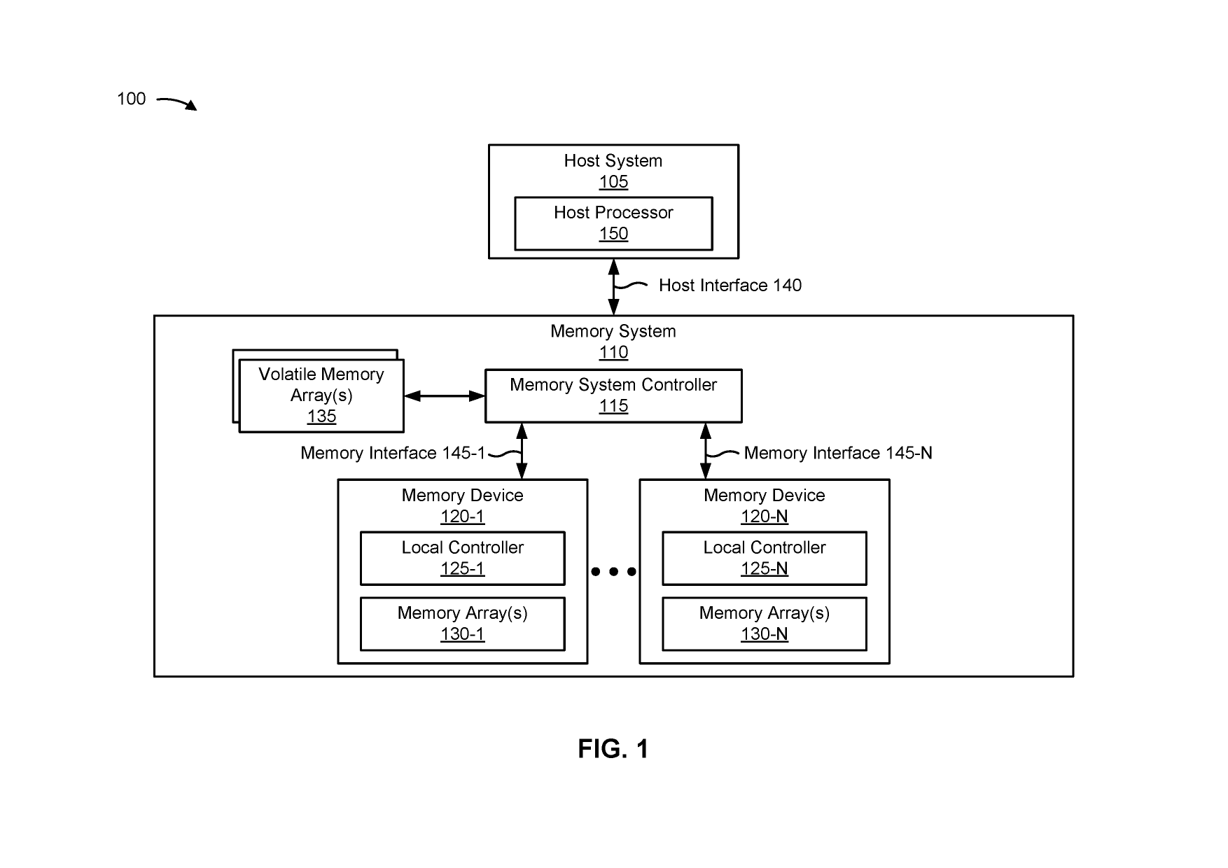

FIG. 1 is a diagram illustrating an example system 100 capable of combined passthrough and link parity information. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N ≥ 1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N ≥ 1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, and/or a DIMM interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory

system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

In some implementations, one or more systems, devices, apparatuses, components, and/or controllers of FIG. 1 may be configured to obtain, from a host system, a first message including data and parity information associated with the data; perform an error control operation on the data using the parity information; and store the data and the parity information to the memory apparatus.

In some implementations, one or more systems, devices, apparatuses, components, and/or controllers of FIG. 1 may be configured to generate parity information for data associated with a write request; provide, to a memory apparatus, an indication that the memory apparatus is to perform a link error control operation on the data using the parity information and that the memory apparatus is to store the parity information; and provide, to the memory apparatus, a first message including the data and the parity information.

In some implementations, one or more systems, devices, apparatuses, components, and/or controllers of FIG. 1 may be configured to a host system; a memory apparatus; a host interface between the host system and the memory apparatus; and communicate, via the host interface and to the memory apparatus, a first message including data and parity information associated with the data; perform an error control operation on the data using the parity information; and store the data and the parity information to the memory apparatus.

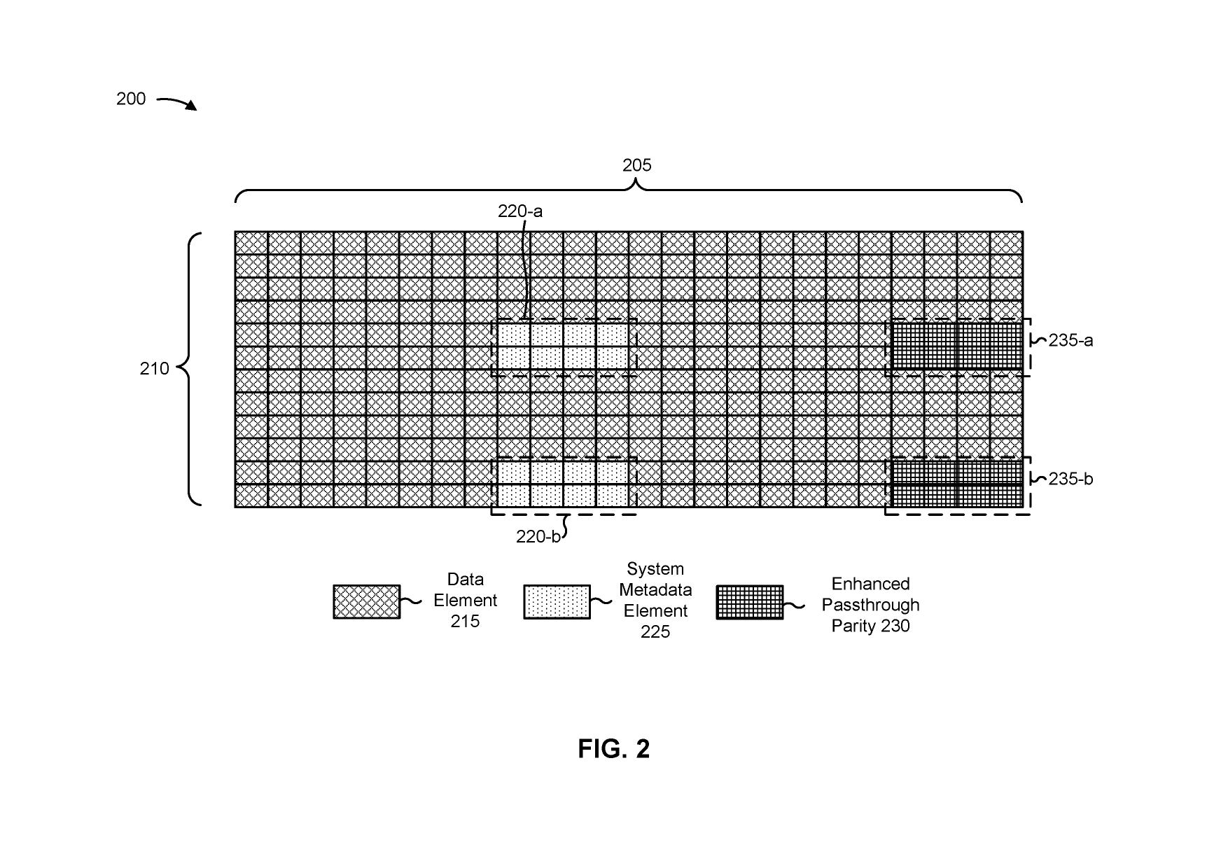

FIG. 2 shows an example of a data packet 200 that supports combined passthrough and link parity information. The data packet 200 illustrates a format of signaling communicated between a host system (e.g., the host system 105) and a memory apparatus (e.g., the memory system 110, one or more memory devices 120) specified by a communication protocol, such as a format used for a burst operation (e.g., a write burst operation and/or a read burst operation).

The data packet 200 may include one or more elements arranged according to one or more time intervals 205, which may be referred to as “beats”, and one or more pins 210 of a bus (e.g., a host interface 140) between the host system and the memory apparatus. Said another way, each pin 210 of the bus may communicate a single element between the host system and the memory system during each time interval 205. An element corresponding to a given time interval 205 and a given pin 210 may represent a voltage level of the given pin 210 during the given time interval 205. For

example, an element may be a single bit, such as a high state (e.g., a logic “1) or a low state (e.g., a logic “0”) at an edge (e.g., a rising edge, a falling edge) of a clock signal used as part of binary signaling. Additionally, or alternatively, an element may correspond to a voltage level of other signaling schemes, such as non-return-to-zero (NRZ) signaling, three-level pulse-amplitude modulation (PAM-3) signaling, and/or PAM-4 signaling, among other examples.

The one or more elements may include one or more data elements 215. The one or more data elements 215 of the data packet may represent the payload of the data packet 200, such as user data communicated between the host system and the memory system.

In some examples, the communication protocol may specify one or more locations 220 (e.g., one or more subsets of the time intervals 205 and/or the pins 210, one or more portions of the data packet 200) within the data packet 200 to include control information associated with the payload of the data packet 200. For example, the communication protocol may specify that system metadata may be included at a location 220-a and/or a location 220-b, as illustrated in FIG. 2. Said another way, the communication protocol may provision the locations 220 for system metadata. In some cases, the host system may place one or more system metadata elements 225 in the locations 220. For example, the host system may include additional parity information or other system metadata to improve the reliability of the data packet 200. The memory system may be configured to store the system metadata to one or more memory arrays provisioned for system metadata associated with the payload.

In some examples, the memory system may use the one or more locations 220 to report a status of one or more fault-mode registers of the memory system. A fault-mode register may be a register within the memory system configured to log one or more error conditions, such as critical errors, write-link errors, or other conditions detected during operation. A fault-mode register may include a binary indicator (e.g., a flag), a detailed error code, and/or a value that provides additional context about the nature and severity of a fault. In some examples, the host system may provide, and the memory system may obtain, a request for a status of the one or more fault-mode registers. Based on, in response to, or otherwise associated with obtaining the request, the memory system may provide a message indicating the value (e.g., the status) of the one or more fault-mode registers to the host system, for example by placing the status in the locations 220. Additionally, the communication protocol may specify that

communication control information may be included at a location 235-a and/or 235-b, as illustrated in FIG. 2. Said another way, the communication protocol may provision the locations 235 for communication control information.

The host system and/or the memory system may support a combined passthrough parity and link parity mode in which the memory system may use parity information included in the locations 235 as both passthrough parity information and link parity information. Such combined parity information may be called enhanced passthrough parity information. In such a mode, the host system and/or the memory system may place one or more enhanced passthrough parity elements 230 in the locations 235. By way of example, as part of generating a first data packet 200 for a write burst operation, the host system may generate the enhanced passthrough parity elements 230 by performing an error control operation on a payload of the first data packet 200 (e.g., on one or more data elements 215), as well as the information in the locations 220 (e.g., the one or more system metadata elements 225). Said another way, the enhanced passthrough parity information may be an ECC of the error control operation. The host system may place the enhanced passthrough parity elements 230 in the locations 235. The host system may provide, and the memory system may obtain, the first data packet 200.

After obtaining the first data packet 200, the memory system may use the enhanced passthrough parity elements 230 to perform an error control operation on the first data packet 200. The memory system may store the enhanced passthrough parity elements 230 to one or memory arrays provisioned for parity information associated with the data packet 200. In some examples, the memory system may provision storage space within a memory device (e.g., a memory device 120) to store parity information, such as on-die parity information. On-die parity information for a data packet 200 may include parity information generated by the memory system using the payload and/or system metadata of a data packet 200. The memory system may use on-die parity information to detect and/or correct errors in the payload that occur as part of internal processing of the payload (e.g., errors that occur as part of the memory system storing and/or retrieving the payload).

However, if the memory system is operating in the combined passthrough and link parity information mode, then the memory system may use the one or memory arrays provisioned for parity information to instead store the enhanced passthrough parity information. In such cases, the memory system may refrain from generating on- die parity information, which may reduce the processing load on the memory system and thus improve system performance.

Subsequently, as part of a read operation for the payload, the memory system may generate a second data packet 200. For example, the memory system may retrieve the payload, the enhanced passthrough parity information, and/or the system metadata form one or more memory arrays. The memory system may place the enhanced passthrough parity information in location 235 of the second data packet 200. The memory system may provide, and the host system may obtain, the second data packet 200. Based on, in response to, or otherwise associated with obtaining the second data packet 200, the host system may perform an error control operation on the second data packet using the enhanced passthrough parity information to detect and/or correct one or more errors in the second data packet 200. As shown in FIG. 2, the one or more pins 210 may include a pin 210 used to communicate a subset of the one or more data elements 215, a subset of the one or more system metadata elements 225, and a subset of the one or more enhanced passthrough parity elements 230. In some examples, the host system and/or the memory system may concurrently communicate a subset of the one or more data elements 215 and a subset of the one or more system metadata elements 225 (e.g., by communicating such elements over multiple pins 210 within a single time interval 205). Additionally, the host system and/or the memory system may concurrently communicate a subset of the one or more data elements 215 and a subset of the one or more enhanced passthrough parity elements 230.

To support combined passthrough and link parity information, the host system and the memory system may use the same parity matrix to perform error control operations, such as generating the enhanced passthrough parity elements 230 and/or using the enhanced passthrough parity elements 230 to detect and/or correct error(s) in a data packet 200. A parity matrix may include or may be based on one or more parity-check equations. For example, one or more rows of a parity matrix may correspond to or may be based on respective parity-check equation(s). One or more columns of the parity matrix may correspond to respective bit positions in the data packet 200. If one or more errors exist in the data packet 200, a product of the parity matrix and a data vector based on the data packet 200 (e.g., a syndrome of the data packet 200) may deviate from an expected null vector, which may allow the host system and/or the memory system to identify and/or correct the error(s).

The host system and/or the memory system may configure the parity matrix used to manage the enhanced passthrough parity information. For example, the parity matrix may be specified (e.g., defined, dictated) by a communication protocol between the host system and the memory apparatus. Additionally, or alternatively, the host system and/or the memory system may select the parity matrix from multiple supported parity matrices. For example, the host system may provide, and the memory system may obtain a configuration request that indicates the parity matrix to be used for the enhanced passthrough parity information. Said another way, the host system may program the parity matrix to the memory system, such as by including or otherwise indicating the parity matrix in the configuration request. In some examples, the configuration request may include the parity matrix. Additionally, or alternatively, the host system and/or the memory system may store a library or other database of supported parity matrices. In such cases, the configuration request may indicate a particular parity matrix of the supported parity matrices to be used for the enhanced passthrough parity information.

By including the enhanced passthrough parity elements 230, the host system and/or the memory system may reduce the quantity of operations used to implement parity protection for a data packet while reducing the likelihood of errors occurring during transmission of the data packet. For example, by including enhanced passthrough parity information in a data packet 200, the host system may improve the reliability of the data packet without issuing additional access commands for other types of parity information, such as in-line parity information. Additionally, by using the enhanced passthrough parity information to detect and/or correct write-link errors in the data packet 200, the memory system may improve the reliability of the data packet 200 without using additional system resources to manage additional link parity information. Such combined passthrough and link parity information may also allow for additional control information to be included in a data packet, such as system metadata, inversion information, and/or error reporting information, among other examples.

As indicated above, FIG. 2 is provided as an example. Other examples may differ from what is described with regard to FIG. 2.

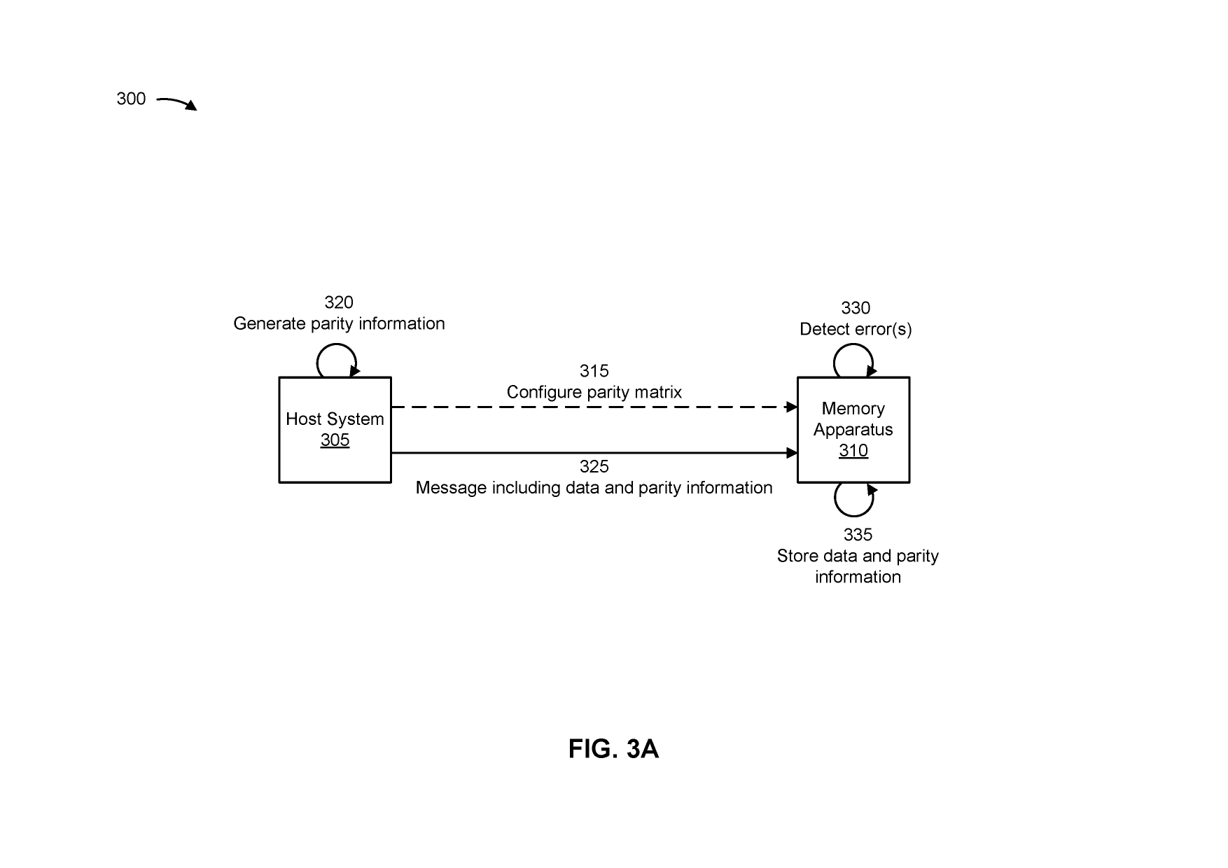

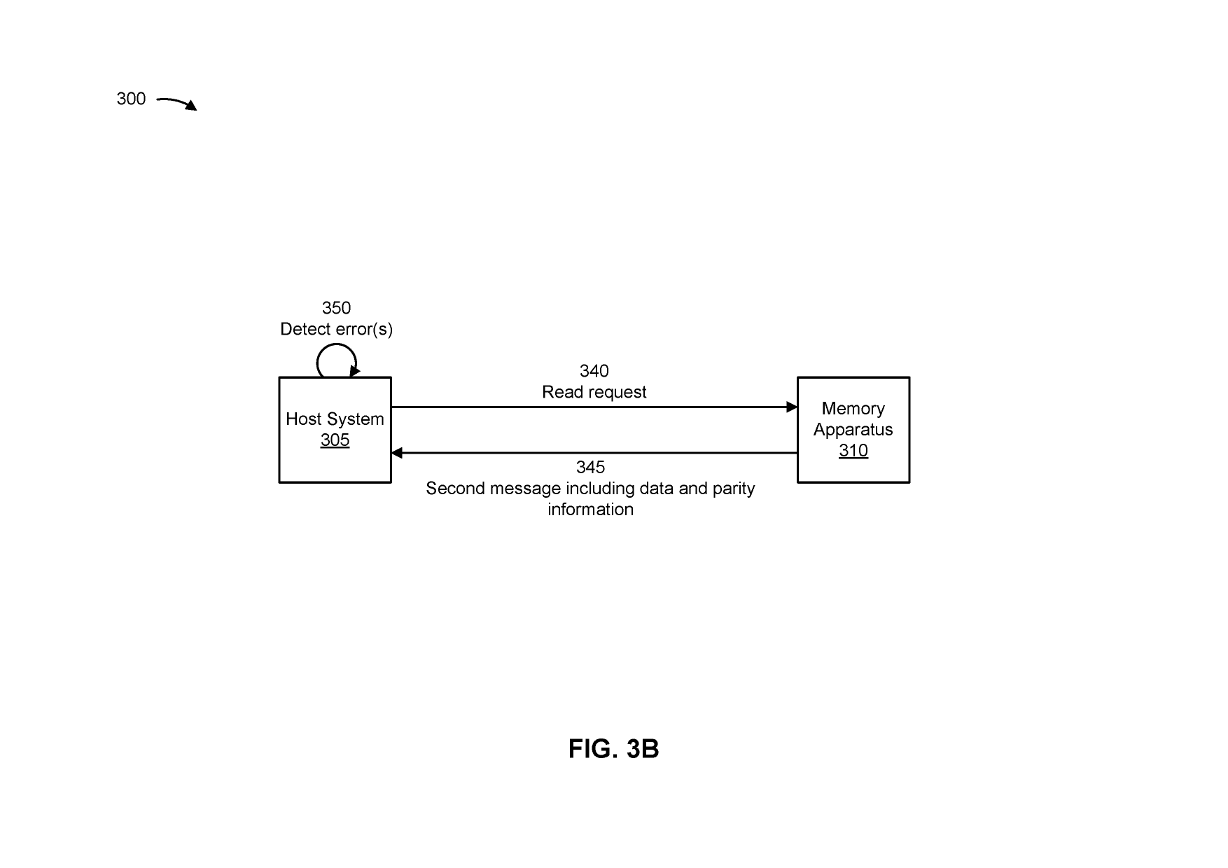

FIGS. 3A and 3B are diagrams of an example 300 of combined passthrough and link parity information. The operations described in connection with FIGS. 3A and 3B may be performed by a system, such as the system 100 and/or one or more components thereof, such as the host system 105, the host interface 140, the memory system 110, the

memory system controller 115, one or more memory devices 120, and/or one or more local controllers 125.

As shown in FIGS. 3A and 3B, the example 300 may include a host system 305 and a memory apparatus 310. The host system 305 may be the host system 105. The memory apparatus 310 may be or may include the memory system 110, one or more memory devices 120, and/or one or more controllers (e.g., the memory system controller 115 and/or one or more local controllers 125).

The example 300 illustrates a process to enable the host system 305 and the memory apparatus 310 to perform error control operations using passthrough parity information, such as by detecting and/or correcting one or more write-link errors. The host system 305 and to memory apparatus 310 may perform, at least in part, such error control operations using a parity matrix associated with an error control scheme (e.g., a single-error correction (SEC) scheme, a SEC double-error detection (SECDED) scheme, among other examples).

In some examples, as shown by reference number 315, the host system 305 may provide, and the memory apparatus 310 may obtain, a configuration request to identify or otherwise configure the parity matrix. For example, the configuration request may include the parity matrix. Said another way, the host system 305 may program the parity matrix to the memory apparatus 310, such as by including or otherwise indicating the parity matrix in the configuration request. Additionally, or alternatively, the host system 305 and/or the memory apparatus 310 may store a library or other database of supported parity matrices. In such cases, the configuration request may indicate a particular parity matrix of the supported parity matrices.

As shown by reference number 320, the host system 305 may generate enhanced passthrough parity information for a payload and/or system metadata of a first data packet to be written to the memory apparatus 310. For example, the host system 305 may generate the enhanced passthrough parity information by performing, using the parity matrix, one or more error control operations on the payload and the system metadata. As shown by reference number 325, the host system 305 may provide, and the memory apparatus 310 may obtain, a first message that includes the payload, the enhanced parity information, and/or the system metadata (e.g., the first data packet).

In some examples, the host system 305 may provide, and the memory apparatus 310 may obtain, an indication that the memory apparatus 310 is to perform a link error control operation on the first data packet using the enhanced passthrough parity information and that the memory apparatus 310 is to store the enhanced passthrough parity information. For example, the host system 305 may provide a write request for the first data packet indicating that the memory apparatus 310 is to operate in a combined passthrough and link parity information mode (e.g., using an operational code). Additionally, or alternatively, the host system 305 may set a mode register of the memory apparatus 310 (e.g., via a mode register write command), such as by storing a value to the mode register, to indicate that the memory apparatus 310 is to operate in the combined passthrough and link parity information mode.

As shown by reference number 330, based on, in response to, or otherwise associated with obtaining the first message, the memory apparatus 310 may perform, using the parity matrix, an error control operation on the first data packet using the enhanced passthrough parity information to detect and/or correct one or more errors (e.g., one or more write-link errors) in the first data packet. As shown by reference number 335, the memory apparatus 310 may store the payload and/or the system metadata to one or more memory arrays of the memory apparatus 310. Additionally, the memory apparatus 310 may store the enhanced passthrough parity information to one or memory arrays provisioned for parity information. In some examples, the memory apparatus 310 may refrain from generating on-die parity information for the first data packet, which may reduce the processing load on the memory system and thus improve system performance.

As shown in FIG. 3B, the example 300 further illustrates a process to enable the host system 305 to retrieve the payload and the enhanced passthrough parity information from the memory apparatus 310. For example, as shown by reference number 340, the host system 305 may provide, and the memory apparatus 310 may obtain, a read request to retrieve the payload. Based on, in response to, or otherwise associated with obtaining the read request, the memory apparatus 310 may retrieve the payload and the enhanced passthrough parity information from the one or more memory arrays.

The memory apparatus 310 may place the enhanced passthrough parity information in one or more portions of a second data packet provisioned for communication control information (e.g., one or more locations 235). As shown by reference number 345, the memory apparatus 310 may provide, and the host system 305 may obtain, a second message that includes the payload and the enhanced passthrough parity information. For example, the second message may include or may be the second data packet that includes the payload and the enhanced passthrough parity information. In some examples, the memory apparatus 310 may refrain from generating link parity information for the second data packet, which may reduce the processing load on the memory apparatus 310 and thus improve system performance.

As shown by reference number 350, based on, in response to, or otherwise associated with obtaining the second data packet, the host system 305 may perform an error control operation on the second data packet using the enhanced passthrough parity information to detect and/or correct one or more errors in the second data packet.

As indicated above, FIGS. 3A and 3B are provided as an example. Other examples may differ from what is described with regard to FIGS. 3A and 3B.

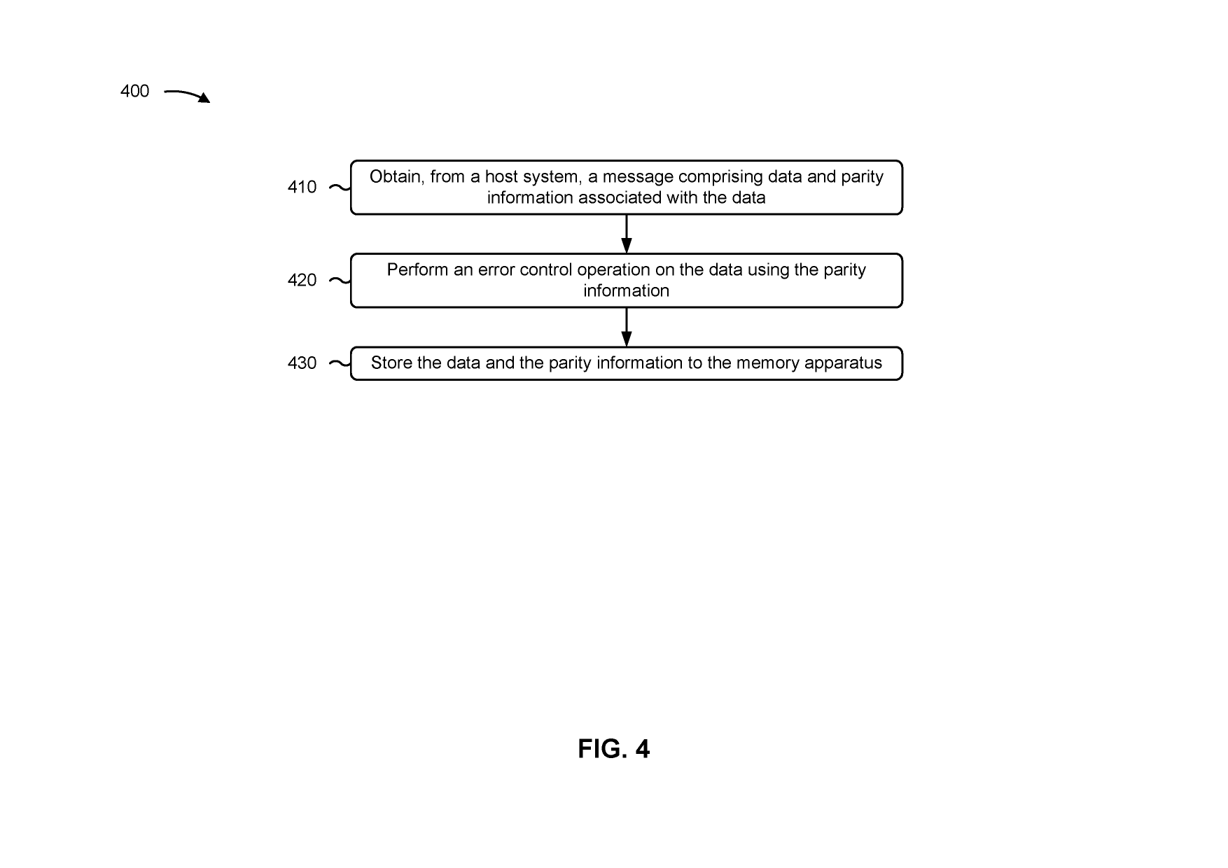

FIG. 4 is a flowchart of an example method 400 associated with combined passthrough and link parity information. In some implementations, a memory apparatus (e.g., the memory system 110 and/or the memory apparatus 310) may perform or may be configured to perform the method 400. In some implementations, another device or a group of devices separate from or including the memory apparatus (e.g., the host system 105, the host interface 140, and/or the host system 305) may perform or may be configured to perform the method 400. Additionally, or alternatively, one or more components of the memory apparatus (e.g., the memory system controller 115, one or more memory devices 120, and/or one or more local controllers 125) may perform or may be configured to perform the method 400. Thus, means for performing the method 400 may include the memory apparatus and/or one or more components of the memory apparatus. Additionally, or alternatively, a non-transitory computer-readable medium may store one or more instructions that, when executed by the memory apparatus, cause the memory apparatus to perform the method 400.

As shown in FIG. 4, the method 400 may include obtaining, from a host system, a first message including data and parity information associated with the data (block 410). As further shown in FIG. 4, the method 400 may include performing an error control operation on the data using the parity information (block 420). As further shown in FIG. 4, the method 400 may include storing the data and the parity information to the memory apparatus (block 430).

The method 400 may include additional aspects, such as any single aspect or any combination of aspects described below and/or described in connection with one or more other methods or operations described elsewhere herein.

In a first aspect, the method 400 includes obtaining, from the host system, a read request for the data, and providing, to the host system, a second message including the data and the parity information.

In a second aspect, alone or in combination with the first aspect, the method 400 includes refraining, as part of performing the read request, from generating link parity information for the data based on obtaining the parity information.

In a third aspect, alone or in combination with one or more of the first and second aspects, the method 400 includes identifying a status of one or more fault-mode registers of the memory apparatus, and providing the status to the host system, where the second message further includes the status.

In a fourth aspect, alone or in combination with one or more of the first through third aspects, the method 400 includes detecting, as part of the error control operation, one or more errors in the data, and storing, to the one or more fault-mode registers, a value indicating that the one or more errors were detected, where the status is based on the value.

In a fifth aspect, alone or in combination with one or more of the first through fourth aspects, the method 400 includes refraining from generating on-die parity information for the data based on obtaining the parity information.

In a sixth aspect, alone or in combination with one or more of the first through fifth aspects, the method 400 includes performing the error control operation on the data using the parity matrix.

In a seventh aspect, alone or in combination with one or more of the first through sixth aspects, the method 400 includes configuring the parity matrix based on a configuration request obtained from the host system.

In an eighth aspect, alone or in combination with one or more of the first through seventh aspects, the method 400 includes obtaining a subset of the data via a pin of one or more pins of a bus between the host system and the memory apparatus, and obtaining a subset of the parity information via the pin.

Although FIG. 4 shows example blocks of a method 400, in some implementations, the method 400 may include additional blocks, fewer blocks, different blocks, or differently arranged blocks than those depicted in FIG. 4. Additionally, or alternatively, two or more of the blocks of the method 400 may be performed in parallel. The method 400 is an example of one method that may be performed by one or more devices described herein. These one or more devices may perform or may be configured to perform one or more other methods based on operations described herein.

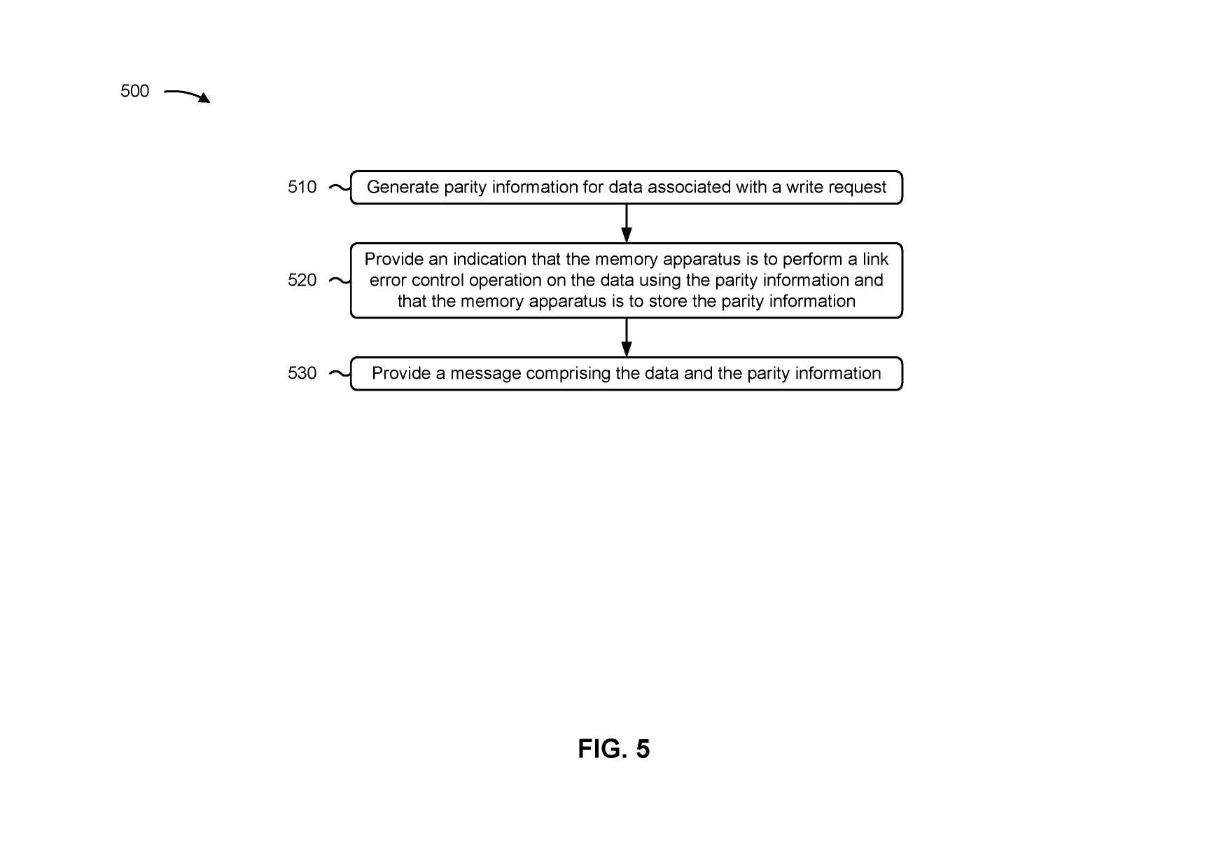

FIG. 5 is a flowchart of an example method 500 associated with combined passthrough and link parity information. In some implementations, a host system (e.g., the host system 105 and/or the host system 305) may perform or may be configured to perform the method 500. In some implementations, another device or a group of devices separate from or including the host system (e.g., the memory system 110, the host interface 140, and/or the memory apparatus 310) may perform or may be configured to perform the method 500. Additionally, or alternatively, one or more components of the host system (e.g., the host processor 150) may perform or may be configured to perform the method 500. Thus, means for performing the method 500 may include the host system and/or one or more components of the host system. Additionally, or alternatively, a non-transitory computer-readable medium may store one or more instructions that, when executed by the host system, cause the host system to perform the method 500.

As shown in FIG. 5, the method 500 may include generating parity information for data associated with a write request (block 510). As further shown in FIG. 5, the method 500 may include providing an indication that the memory apparatus is to perform a link error control operation on the data using the parity information and that the memory apparatus is to store the parity information (block 520). As further shown in FIG. 5, the method 500 may include providing a first message including the data and the parity information (block 530).

The method 500 may include additional aspects, such as any single aspect or any combination of aspects described below and/or described in connection with one or more other methods or operations described elsewhere herein.

In a first aspect, the method 500 includes providing, to the memory apparatus, a read request for the data, obtaining, from the memory apparatus, the data and the parity information, and performing an error control operation on the data using the parity information.

In a second aspect, alone or in combination with the first aspect, the method 500 includes refraining, as part of performing the write request, from generating link parity information for the data.

In a third aspect, alone or in combination with one or more of the first and second aspects, the method 500 includes concurrently providing, to the memory apparatus, a subset of the data and a subset of the parity information.

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. These one or more devices may perform or may be configured to perform one or more other methods based on operations described herein.

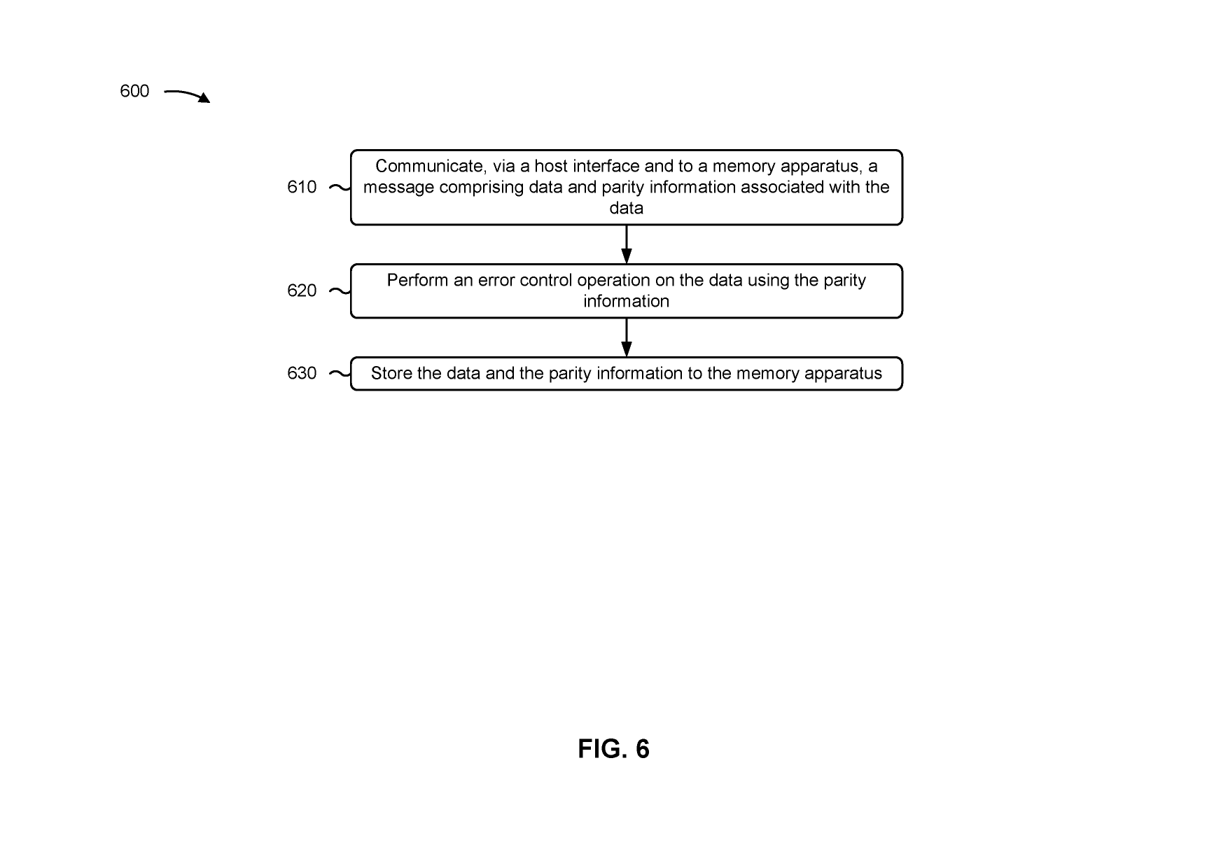

FIG. 6 is a flowchart of an example method 600 associated with combined passthrough and link parity information. In some implementations, a system (e.g., the system 100) may perform or may be configured to perform the method 600. Additionally, or alternatively, one or more components of the system (e.g., the host system 105, the host interface 140, the memory system 110, the host system 305, and/or the memory apparatus 310) may perform or may be configured to perform the method 600. Thus, means for performing the method 600 may include the system and/or one or more components of the system. Additionally, or alternatively, a non-transitory computer-readable medium may store one or more instructions that, when executed by the system, cause the system to perform the method 600.

As shown in FIG. 6, the method 600 may include communicating, via a host interface and to a memory apparatus, a first message including data and parity information associated with the data (block 610). As further shown in FIG. 6, the method 600 may include performing an error control operation on the data using the parity information (block 620). As further shown in FIG. 6, the method 600 may include storing the data and the parity information to the memory apparatus (block 630).

The method 600 may include additional aspects, such as any single aspect or any combination of aspects described below and/or described in connection with one or more other methods or operations described elsewhere herein.

In a first aspect, the method 600 includes communicating, via the host interface and to the memory apparatus, a read request for the data, and communicating, via the host interface and to the host system, a second message including the data and the parity information.

In a second aspect, alone or in combination with the first aspect, the method 600 includes refraining from generating link parity information for the data based on obtaining the parity information.

In a third aspect, alone or in combination with one or more of the first and second aspects, the method 600 includes identifying a status of one or more fault-mode registers of the memory apparatus, and communicating, using the second message, the status to the host system.

In a fourth aspect, alone or in combination with one or more of the first through third aspects, the method 600 includes detecting one or more errors in the data, and storing, to the one or more fault-mode registers, a value indicating that the one or more errors were detected, where the status is based on the value.

In a fifth aspect, alone or in combination with one or more of the first through fourth aspects, the method 600 includes refraining from generating on-die parity information for the data based on obtaining the parity information.

In a sixth aspect, alone or in combination with one or more of the first through fifth aspects, the method 600 includes generating the parity information using a parity matrix, and performing the error control operation using the parity matrix.

In a seventh aspect, alone or in combination with one or more of the first through sixth aspects, the method 600 includes communicating, via the host interface, a configuration request indicating the parity matrix from the host system to the memory apparatus.

In an eighth aspect, alone or in combination with one or more of the first through seventh aspects, the method 600 includes communicating a subset of the data via a pin of one or more pins of the host interface, and communicating a subset of the parity information via the pin.

In a ninth aspect, alone or in combination with one or more of the first through eighth aspects, the method 600 includes concurrently communicating a subset of the data and a subset of the parity information via the host interface.

Although FIG. 6 shows example blocks of a method 600, in some implementations, the method 600 may include additional blocks, fewer blocks, different blocks, or differently arranged blocks than those depicted in FIG. 6. Additionally, or alternatively, two or more of the blocks of the method 600 may be performed in parallel. The method 600 is an example of one method that may be performed by one or

more devices described herein. These one or more devices may perform or may be configured to perform one or more other methods based on operations described herein.

In some implementations, a memory apparatus includes one or more components configured to: obtain, from a host system, a first message including data and parity information associated with the data; perform an error control operation on the data using the parity information; and store the data and the parity information to the memory apparatus.

In some implementations, a host system includes one or more components configured to: generate parity information for data associated with a write request; provide, to a memory apparatus, an indication that the memory apparatus is to perform a link error control operation on the data using the parity information and that the memory apparatus is to store the parity information; and provide, to the memory apparatus, a first message including the data and the parity information.

In some implementations, a system including: a host system; a memory apparatus; a host interface between the host system and the memory apparatus; and one or more components configured to: communicate, via the host interface and to the memory apparatus, a first message including data and parity information associated with the data; perform, by the memory apparatus, an error control operation on the data using the parity information; and store, by the memory apparatus, the data and the parity information to the memory apparatus.

The foregoing disclosure provides illustration and description but is not intended to be exhaustive or to limit the implementations to the precise forms disclosed. Modifications and variations may be made in light of the above disclosure or may be acquired from practice of the implementations described herein.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (e.g., a + a, a + a + a, a + a + b, a + a + c, a + b + b, a + c + c, b + b, b + b + b, b + b + c, c + c, and c + c + c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory apparatus, comprising:
one or more components configured to:
obtain, from a host system, a first message comprising data and parity information associated with the data;
perform an error control operation on the data using the parity information; and
store the data and the parity information to the memory apparatus.

2. The memory apparatus of claim 1, wherein the one or more components are further configured to:
obtain, form the host system, a read request for the data; and
provide, to the host system, a second message comprising the data and the parity information.

3. The memory apparatus of claim 2, wherein the one or more components are further configured to:
refrain, as part of performing the read request, from generating link parity information for the data based on obtaining the parity information.

4. The memory apparatus of claim 2, wherein the one or more components are further configured to:
identify a status of one or more fault-mode registers of the memory apparatus; and
provide the status to the host system, wherein the second message further comprises the status.

5. The memory apparatus of claim 4, wherein the one or more components are further configured to:
detect, as part of the error control operation, one or more errors in the data; and
store, to the one or more fault-mode registers, a value indicating that the one or more errors were detected, wherein the status is based on the value.

6. The memory apparatus of claim 1, wherein the one or more components are further configured to:
refrain from generating on-die parity information for the data based on obtaining the parity information.

7. The memory apparatus of claim 1, wherein the host system is configured to generate the parity information using a parity matrix, and wherein the one or more components are further configured to:
perform the error control operation on the data using the parity matrix.

8. The memory apparatus of claim 7, wherein the one or more components are further configured to:
configure the parity matrix based on a configuration request obtained from the host system.

9. The memory apparatus of claim 1, wherein, to obtain the first message, the one or more components are configured to:
obtain a subset of the data via a pin of one or more pins of a bus between the host system and the memory apparatus; and
obtain a subset of the parity information via the pin.

10. A host system, comprising:
one or more components configured to:
generate parity information for data associated with a write request;
provide, to a memory apparatus, an indication that the memory apparatus is to perform a link error control operation on the data using the parity information and that the memory apparatus is to store the parity information; and
provide, to the memory apparatus, a first message comprising the data and the parity information.

11. The host system of claim 10, wherein the one or more components are further configured to:
provide, to the memory apparatus, a read request for the data;
obtain, from the memory apparatus, the data and the parity information; and
perform an error control operation on the data using the parity information.

12. The host system of claim 10, wherein the one or more components are further configured to:
refrain, as part of performing the write request, from generating link parity information for the data.

13. The host system of claim 10, wherein the one or more components are further configured to:
concurrently provide, to the memory apparatus, a subset of the data and a subset of the parity information.

14. A system comprising:
a host system;
a memory apparatus;
a host interface between the host system and the memory apparatus; and
one or more components configured to:
communicate, via the host interface and to the memory apparatus, a first message comprising data and parity information associated with the data;
perform, by the memory apparatus, an error control operation on the data using the parity information; and
store, by the memory apparatus, the data and the parity information to the memory apparatus.

15. The system of claim 14, wherein the one or more components are further configured to:
communicate, via the host interface and to the memory apparatus, a read request for the data; and
communicate, via the host interface and to the host system, a second message comprising the data and the parity information.

16. The system of claim 15, wherein the one or more components are further configured to:
refrain, by the memory apparatus as part of performing the read request, from generating link parity information for the data based on obtaining the parity information.

17. The system of claim 15, wherein the one or more components are further configured to:
identify, by the memory apparatus, a status of one or more fault-mode registers of the memory apparatus; and
communicate, using the second message, the status to the host system.

18. The system of claim 17, wherein the one or more components are further configured to:
detect, by the memory apparatus as part of the error control operation, one or more errors in the data; and
store, by the memory apparatus and to the one or more fault-mode registers, a value indicating that the one or more errors were detected, wherein the status is based on the value.

19. The system of claim 14, wherein the one or more components are further configured to:
refrain, by the memory apparatus, from generating on-die parity information for the data based on obtaining the parity information.

20. The system of claim 14, wherein the one or more components are further configured to:
generate, by the host system, the parity information using a parity matrix; and
perform, by the memory apparatus, the error control operation using the parity matrix.

21. The system of claim 20, wherein the one or more components are further configured to:
communicate, via the host interface, a configuration request indicating the parity matrix from the host system to the memory apparatus.

22. The system of claim 14, wherein, to communicate the first message, the one or more components are configured to:
communicate a subset of the data via a pin of one or more pins of the host interface; and
communicate a subset of the parity information via the pin.

23. The system of claim 14, wherein the one or more components are configured to:
concurrently communicate a subset of the data and a subset of the parity information via the host interface.
